(19) United States
(12) Patent Application Publication
(10) Pub. No.: US 2002/0035476 A1
(43) Pub. Date: Mar. 21, 2002

(54) E-mail fetching/reading apparatus and recording medium

(76) Inventors: Tadamitsu Ryu, Kashiwa-shi (JP); Masato Numabe, Atsugi-shi (JP); Hideshi Yasuda, Fujisawa-shi (JP)

Correspondence Address: Leighton K. Chong, Ostrager Chong & Flaherty (Hawaii), Suite 1200, 841 Bishop Street, Honolulu, HI, 96813-3908, US

(21) Appl. No.: 09/729,471

(22) Filed: Dec. 1, 2000

(30) Foreign Application Priority Data
Sep. 21, 2000 (JP) 286524/2000

(51) Int. Cl. G06F 15/16; G09G 5/00; G10L 11/00; G10L 21/00

(52) U.S. Cl. 704/272; 709/206; 345/727

(57) ABSTRACT

This invention relates to an e-mail fetching/reading apparatus and recording medium capable of reading by voice whether there is any mail and the content of the mail automatically and remove troublesome and burdensome operations. Thee-mail fetching/reading apparatus according to the invention is structured to notify a user by voice whether there is any e-mail addresses to the user and received at the mail server 1 by making access to the mail server 1 automatically through the network and read by voice the number of received messages, appointed information such as the dates, sender's names, title in the mailer information and/or the content of the e-mail mentioned as the body.

### BACKGROUND OF THE INVENTION

1. Field of the Invention

This invention relates to an e-mail fetching/reading apparatus and recording medium, in particular, relates to an e-mail fetching/reading apparatus that notifies to a user by voice whether there is any e-mail addressed to the user and received at a mail server and reads by voice the received information of the e-mail (number of received messages, sender's names, title, body, etc.)

2. Description of the Related Art

The following is the explanation of the prior art. FIG. 8 is the explanation figure of the prior art. In FIG. 8, 1 indicates a mail server inside a provider, 2 indicates an e-mail file of the mail server 1, 3 indicates a personal computer (PC), 4 indicates a display apparatus connected to the PC 3, 5 indicates an input apparatus (keyboard, mouse, etc.), 6 indicates a main control part, 7 indicates a communication control part which owns an e-mail soft, 8 indicates a memory part(includes hard disk apparatus and memory.)

Transmitting/receiving e-mail through an internet as means for information transmission has come into wide use of late years. This transmitting/receiving e-mail, for example, works by connecting through the network to the mail server 1 of a contracted provider under the control of the communication control part 7 inside the PC.

Generally, provider has a transmitting mail server for transmitting e-mail(s) and a receiving mail server which has a function to keep received e-mail(s). The FIG. 8 shows the mail server I including the transmitting mail server and the receiving mail server. The mail server 1 keeps the received mails (mail #1, mail #2, mail #3, . . . mail #n) in the e-mail file 2.

Therefore, for an user to receive his/her e-mail, the user operates the input apparatus 5 in the PC 3 to start the communication control part 7, makes access to the mail server 1 of the contracted provider through communication instruments such as a modem, a terminal adapter, a router not shown in the figures with a control of the e-mail soft of the communication control part 7, and fetches the corresponding e-mail(s) from the e-mail file 2 in the mail server 1.

E-mail(s) taken in by the PC 3 is(are) recorded once at the memory part 8, Then, the PC starts an display program according to the control of the main control part 6, reads out the e-mail(s) from the memory part 8, indicates on a display screen of the display apparatus 4. And the user looks at the display screen and checks the content of the e-mail addressed to him/her.

Above-mentioned former system had following problems.

To receive e-mail, it was necessary to operate the PC to make access to the provider, fetch e-mail(s), and display the e-mail(s) on the display screen.

However, such operation necessary to receive e-mail(s) is troublesome and burdensome for users unfamiliar with personal computer operations. And even if e-mail(s) was (were) taken into the PC, it was troublesome to display the content on the display screen to read.

This invention has an object to provide an e-mail fetching/reading apparatus and recording medium capable of resolving the former problems by notifying a user by voice whether there is any e-mail addressed to the user and received at a mail server by making access to the mail server automatically through a network, converting the e-mail receiving information (number of received messages, number of senders, title(s), body(s),etc.) automatically to voice, and reading it(them) by voice.

### SUMMARY OF THE INVENTION

The FIG. 1 is a figure to explain the principle of the present invention. This invention is structured as the following to accomplish said objects.

To solve the above-mentioned problems, the invention as described in claim 1 provides an e-mail fetching/reading apparatus structured to notify a user by voice whether there is any e-mail addressed to the user and received at a mail server by making access to the mail server automatically through a network.

To solve the above-mentioned problems, the invention as described in claim 2 provides an e-mail fetching/reading apparatus as defined in claim 1, characterized in that said appaatus reads by voice the number of received messages addressed to the user in the mail server, appointed information such as the dates, sender's names or the titles included in the mailer information and/or the content of the e-mail mentioned as the body.

To solve the above-mentioned problems, the invention as described in claim 3 provides an e-mail fetching/reading apparatus as defined in claim 2, characterized in that said apparatus includes an e-mail fetching part which makes access to the mail server automatically through the network, acquires the e-mail(s) addressed to the user, a mailer information analyzing part which extracts appointed information from the mailer information in the header section of the e-mail and converts the information to words in the data form determined in advance, a sentence editing part which inserts said appointed information analyzed in the mailer information into appointed place(s) in the appointed sentence and edits, a voice compounding process part which compounds the content recorded as the mailer information and the body into a voice signal, an electric sound converting means which converts the voice signal to a voice and makes an output.

To solve the above-mentioned problems, the invention as described in claim 4 provides an e-mail fetching/reading apparatus as defined in claim 3, characterized in that the mailer information analyzing part practices the analysis referring to an already instituted information table about the mailer information such as the dates, sender's names, and title, demands an attribute in each word, attaches the attribute to the each word and converts into a word in the data form, and rearranges the words into a appointed order. All these functions are installed.

To solve the above-mentioned problems, the invention as described in claim 5 provides an e-mail fetching/reading apparatus as defined in claim 3, characterized in that the sentence editing part inserts the words, which are analyzed and rearranged by said mailer information analyzing part, into the appointed place(s) in the appointed sentence, deletes meaningless words or characters when read by voice, and edits so that the sentence is easy to understand.

To solve the above-mentioned problems, the invention as described in claim 6 provides an e-mail fetching/reading apparatus as defined in claim 3, characterized in that said apparatus includes, a dictionary with proper nouns and other words, which are likely to appear in the e-mail(s), and their pronunciations corresponding thereto, and the voice compounding process part has a function which refers this dictionary and compounds voice signal.

To solve the above-mentioned problems, the invention as described in claim 7 provides an e-mail fetching/reading apparatus as defined in any of claims 3 to 6, characterized in that at least the electric sound converting means in the e-mail fetching/reading apparatus is put inside the stuffed animal.

To solve the above-mentioned problems, the invention as described in claim 8 provides a computer readable recording medium which has a program to notify a user by voice whether there is any e-mail addressed to the user and received at a mail server by making access to the mail server automatically through a network.

To solve the above-mentioned problems, the invention as described in claim 9 provides a computer readable recording medium as defined in claim 8, characterized in that the computer is functioned to read by voice the number of received messages addressed to the user in the mail server, appointed information such as the dates, sender's names or the titles included in the mailer information and/or the content of the e-mail mentioned as the body.

A description will be given based on the FIG. 1 about the function of this invention based on said structure.

(a): According to the invention as described in claim 1, when starting an apparatus, the apparatus makes access to a mail server automatically through the network and checks whether there is any received e-mail addressed to herself/himself in the mail box. The apparatus notifies the existence or non-existence of such e-mail(s) by voice. By structuring this way, checking e-mail(s) is possible without troublesome and burdensome operations of the PC.

(b): According to the invention as described in claim 2, the apparatus reads by voice the number of received messages addressed to the user in the mail server, appointed information such as the dates, sender's names or the titles included in the mailer information and/or the content of the e-mail mentioned as the body if there's received e-mail(s). By structuring this way, recognizing the content of the e-mail is possible without troublesome and burdensome operations of the PC.

(c): According to the invention as described in claim 3, the e-mail fetching part makes access to the mail server automatically through the network, and acquires the e-mail(s) addressed to herself/himself. The mailer information analyzing part extracts the appointed information from the mailer information in the header section of the e-mail and converts the information to words in the data form determined in advance. The sentence editing part inserts said appointed information analyzed in the mailer information into the appointed place(s) in the appointed sentence and edits. The voice compounding process part compounds the content recorded as the mailer information and the body into the voice signal. And the electric sound converting means converts the voice signal to a voice and makes an output. By structuring this way, it is possible to check the necessary e-mail information by voice and get rid of troublesome and burdensome operations of the PC.

(d): According to the invention as described in claim 4, the mailer information analyzing part practices the analysis with referring to the pre-instituted information table about the mailer information such as the dates, sender's names, and title included in the mailer information, identifies the attribute in each word, attaches the attribute to the each word and converts into word(s) in the predetermined data form, and rearranges the words into the appointed order. By structuring this way, it is possible to extract necessary information such as date, sender's name, title, etc. in a specific form from the mailer information described in the header section.

(e): According to the invention as described in claim 5, the sentence editing part inserts the words, which are analyzed and rearranged by the mailer information analyzing part, into the appointed place(s) in the appointed sentence, deletes meaningless words or characters when read by voice, and edits so that the sentence is easy to understand By structuring this way, it is possible to convert into a sentence easy to understand when read out

(f): According to the invention as described in claim 6, the voice compounding process part refers the dictionary with proper nouns and other words, which are likely to appear in the e-mails), and their pronunciations corresponding thereto, and compounds into the voice signal. By structuring this way, there is less mistakes in reading and the appratus can change to words easier to listen.

(g): According to the invention as described in claim 7, in the e-mail fetching/reading apparatus, at least the electric sound converting means is put inside the stuffed animal. By structuring this way, it is possible to make it seem as if the stuffed animal is the one who notifies a user whether there is any received mail addressed to the user and reads out the content of the e-mail.

(h): According to the invention as described in claim 8, a computer operates to read a program recorded in the computer readable recording medium thereby making access to a mail server 1 automatically through the network, and notifying the user whether there is any e-mail addressed to the user and received at the mail server. By structuring this way, checking e-mail is possible without troublesome and burdensome operations of the PC.

(i): According to the invention as described in claim 9, a computer operates to read a program recorded in the computer readable recording medium thereby reading by voice the number of received messages addressed to the user in the mail server, appointed information such as the dates, sender's names or the titles included in the mailer information and/or the content of the e-mail mentioned as the body. By structuring this way, recognizing the content of the e-mail is possible without troublesome and burdensome operations of the PC,

### BRIEF DESCRIPTION OF THE DRAWINGS

FIG. 1 is a principle explanatory view of the present invention.

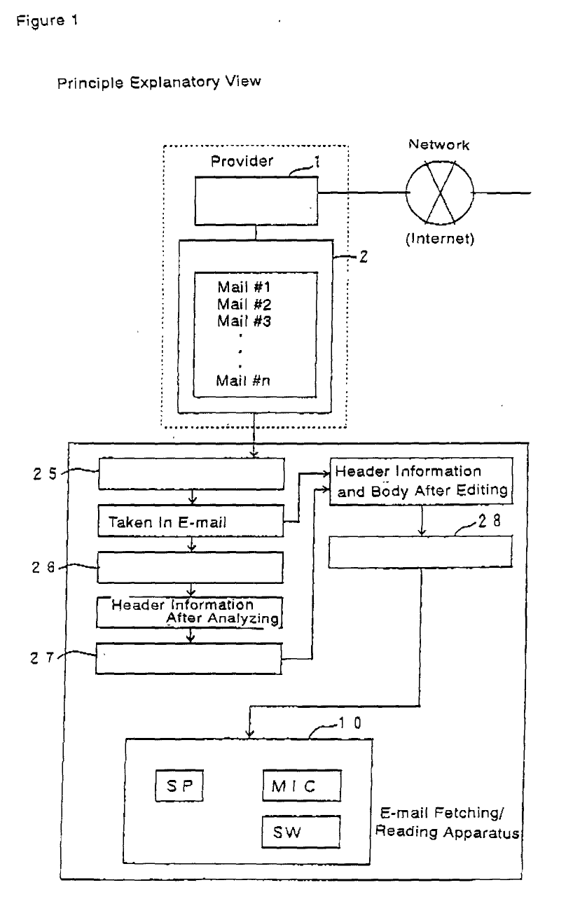

FIG. 2 is an explanatory view of one embodiment of the e-mail fetching/reading apparatus in accordance with the present invention. FIG. 2A is a block view of the e-mail fetching/reading apparatus, and FIG. 2B is an explanatory view of the e-mail.

FIG. 3 is a detailed block view of one embodiment of the e-mail fetching/reading apparatus in accordance with the present invention.

FIG. 4 is a flowchart of one embodiment of the e-mail fetching/reading process in accordance with the present invention.

FIG. 5 is an explanatory view of the example table in accordance with the present invention. FIG. 5A is an example contents information table, and FIG. 5B is an example vocabulary dictionary.

FIG. 6 is a specific example of the stuffed animal in accordance with the present invention. FIG. 6A is a front view and FIG. 6B a perspective view.

FIG. 7 is an example specific apparatus in accordance with the present invention.

FIG. 8 is an explanatory view of the prior art.

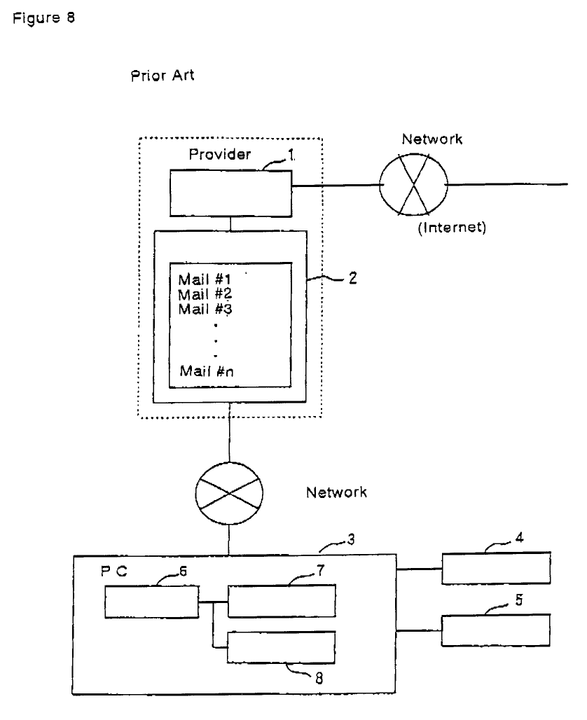

### DETAILED DESCRIPTION OF THE PREFERRED EMBODIMENTS

The following is an explanation of the one embodiment of the present invention grounded on the drawings.

§1: An explanation of the e-mail fetching/reading apparatus

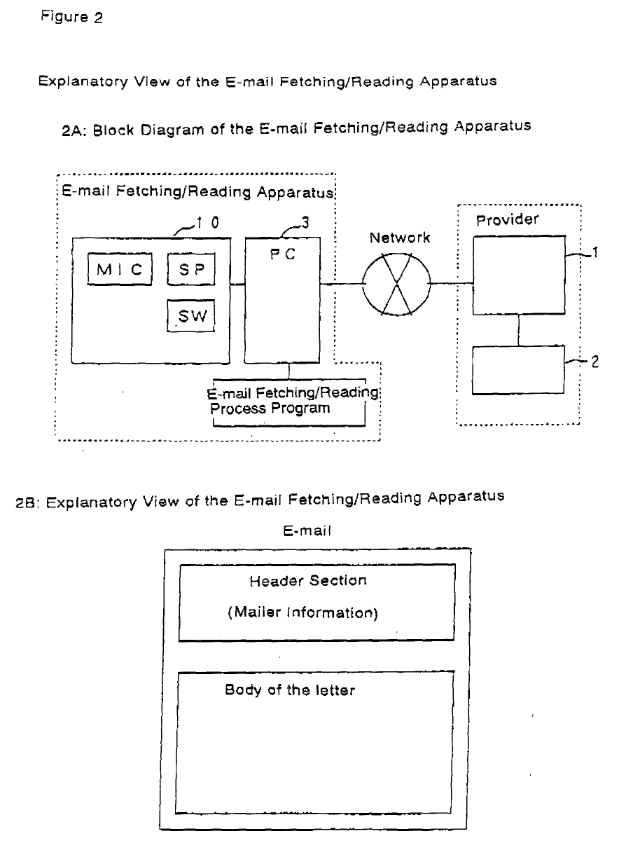

FIG. 2 is the explanatory view of the e-mail fetching/reading apparatus. FIG. 2A is the block view of the e-mail fetching/reading apparatus and FIG. 2B is the explanatory view of the e-mail.

The e-mail fetching/reading apparatus consists of personal computer (PC) 3 and the doll or the stuffed animal 10 for example, as shown in FIG. 2. In this case, the stuffed animal 10 should be any animal such as a cat and a mouse or a character from cartoons, TV shows, or movies.

And this stuffed animal 10 has a microphone MIC which converts user's voice to electric signals, a speaker SP (the electric sound converting means) which converts the voice compounded signal to voice, and a switch SW are built-in. These constitutes elements are connected to appointed places inside the PC 3 electrically by lead lines. Moreover, necessary power of the stuffed animal 10 is supplied from the PC 3. Of course, necessary power of the stuffed animal 10 can be supplied from batteries or AC adapter.

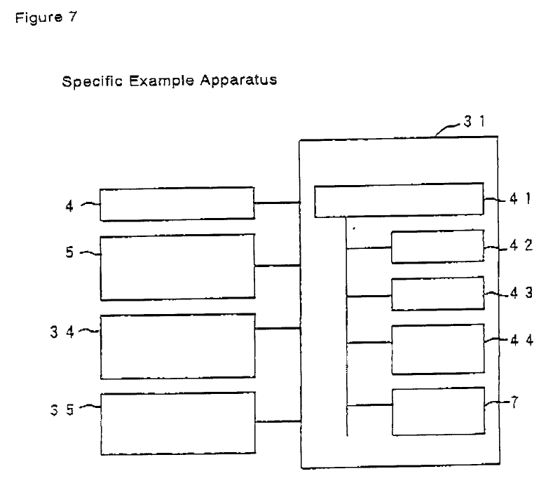

Aforesaid PC 3 is, as shown in FIG. 7, consisted of body of the computer 31, display apparatus 4 connected to the body of the computer 31, input apparatus 5 (keyboard/mouse), removable disk drive (RDD) 34, hard disk apparatus (HDD) 35, or all the necessary apparatus to put normal PC functions into practice.

Body of the computer 31 has CPU 41 which practices internal control and process, ROM 42 (non-volatile memory) which stores programs and various data, RAM (random access memory) 43, interface control part (I/F control part) 44, and communication control part 7 etc.. The RDD 34 comprises flexible disk drive (floppy disk drive) and optical disk drive.

Programs and data are stored in the hard disk apparatus 35 of the PC 3, “E-mail Fetching/Reading Processing Program” which is necessary to practice e-mail fetching/reading process is stored as well. This e-mail fetching/reading processing program is to work with Windows (trademark) 95, Windows (trademark) 98, Windows (trademark) ME, Windows (trademark) 2000, Windows (trademark) NT, and other OS.

On the other side, provider also has a same computer structured as the PC 3. The explanation is omitted but it is connectable to internet. It has the transmission mail server for the e-mail transmission and the receiving mail server with a function to keep e-mail(s) received through the internet. Transmission mail server and receiving mail server are included in the mail server 1 illustrated in FIG. 2. The mail server 1 keeps received e-mails (mail #1, mail #2, mail #3, . . . mail #n) in the e-mail file 2.

The e-mail, as shown in FIG. 2B, is constituted of header part and the body. In this case, the header part is made out automatically by a mailer which is made by a mail software. Information such as date, sender's name, address, title of the e-mail, are written in the header part. The information written in the header is called “mailer information.”

§2: A detailed explanation of the e-mail fetching/reading apparatus

(1): A detailed explanation of the structure of the e-mail fetching/reading apparatus

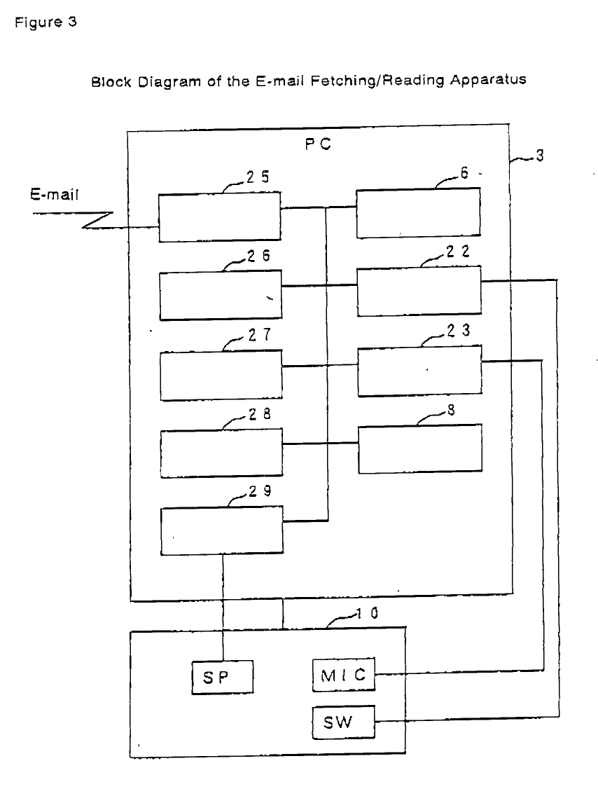

FIG. 3 is the block diagram of the detailed explanation of the e-mail fetching/reading apparatus.

The e-mail fetching/reading apparatus, as shown in FIG. 3, has main control part 6 which controls the inside of the PC 3 wherein the necessary apparatus are structured inside to put normal PC functions into practice, switch condition detecting part 22 which detects the on/off condition of the switch SW installed in the stuffed animal 10, voice recognition processing part 23 which recognizes voice signals inputted from the microphone MIC of the stuffed animal 10 (can be used the widely known voice recognition software), and memory part 8 (includes hard disk apparatus, memory like RAM), e-mail fetching part 25 which makes access to the provider through the communication apparatus such as modem, terminal adapter, router( not shown in the drawings) and acquires particular e-mail(s) into PC 3, the mailer information analyzing part 26 which extracts appointed information from the mailer information in the header section of the e-mail and converts the information to words in the data form determined in advance, the sentence editing part 27 which inserts said appointed information analyzed in the mailer information into the appointed place(s) in the appointed sentence and edits, the voice compounding process part 28 which compounds edited mailer information and the content recorded as the body into a voice signal, and the voice output control part 29 which converts the voice signal to a voice and makes an output control (on power for output etc.)

In this connection, the e-mail fetching part 25, the mailer information analyzing part 26, and the sentence editing part 27 are to put into practice by “E-mail Fetching/Reading Processing” shown in FIG. 2.

The e-mail fetching part 25 possesses information necessary to make automatic access to the mail server 1 of the provider. Specifically, phone number of the provider, a user's ID, a password, a receiving mail server address (POP 3), a mail account, etc. This e-mail fetching part 25 recognizes the user's voice such as “go and acquire my e-mail(s)” by voice recognition processing part 23. Under the control of the main control part 6, the e-mail fetching part 25 commences to process an automatic e-mail fetching step.

In the e-mail fetching part 25, it is also capable of setting an automatic fetching time intervals. By setting the time to 10 minutes, 30 minutes, 1 hour, 6 hours, 12 hours, 24 hours, for example, it makes access to the mail server 1 automatically at each interval.

Alternatively, it is capable of commencing the e-mail fetching part 25 to process automatic e-mail fetching by detecting the condition of the switch SW without relying on the user's voice information recognition.

Moreover, it is also capable of accessing the mail server 1 with a voluntary operation by the user instead of automatically. Structure to commence the e-mail fetching part to process automatic e-mail fetching by having the user input orders to fetching e-mail to main control part 6 from the input apparatus 5.

Moreover, e-mail fetching is done individually by e-mail fetching part 25, therefore, even if other mail soft is already housed in PC 3, it is possible to use without any influence to that mail soft.

(2): An explanation of the process of the e-mail fetching/reading apparatus

The following is the explanation of the process of the e-mail fetching/reading apparatus. First, turn on the switch SW of the stuffed animal 10. In the PC 3 at this time, SW condition detecting part 22 is detecting the condition of the switch SW. When it detects that the SW is turned on, extracts the message already in the memory part 8 and transmits to voice compounding process part 28 by the control of the main control part 6.

At this time, voice compounding process part 28 voice compounds said message. The voice output control part 29 makes output to the speaker inside the stuffed animal 10 while controlling the voice By this, the voice comes out from the speaker SP. Some examples of the voice are “I'll go and get the e-mail. Wait a little bit.” and “I wonder if there's any mail.”

When the user responds to its voice, such as “go and acquire e-mail”, the user's voice is inputted from the microphone MIC and recognizes by voice recognition processing part 23 As a result, the control of the main control part 6 commences the e-mail fetching part 25 to process automatic e-mail fetching.

In this case, e-mail fetching part 25 reads out information such as user's mail address, user's ID, password, already installed in the hard disk of PC 3. Transmit the information to the provider and demands extract of the e-mail. Extract user's e-mail from the e-mail file 2 of the provider's mail server 1, and transmit the result to PC 3.

The e-mail fetching part 25 receives e-mail from the provider and keeps in the memory part 8 temporarily.

Secondly, mailer information analyzing part 26 extracts e-mail in the memory part 8, practices the analysis referring to an already instituted information table about the mailer information such as the dates, sender's names, and title in the header section. The explanation about the process of the mailer information analyzing part will be stated later.

Subsequently, the sentence editing part 27 inserts said appointed information in the mailer information into the appointed place in the appointed sentence and edits. The edited sentences are sent to the voice compounding process part 28. Here, it voice compounds the sentences and converts it into voice signals. The voice signals are controlled by the voice output control part 29, and the voice comes out from the speaker SP of the stuffed animal 10. At this time, after the mailer information such as the dates, sender's names, and title in the header section comes out from the speaker SP, it extracts the content of the body from the e-mail in the memory part 8, voice compounds by the voice compounding process part 28, and makes output with the information in the mailer information from the speaker SP. The number of received messages, sender's names, title, and body are read out. It reads out like “There are several mails”, “From Mr. Kennedy and Ms. Lobinson”, “This is the mail from Mr. Bush”, “Title is PICNIC TO LEXINGTON PARK”, “. . . the body of the mail . . . ”. When there's an attached file to a mail, it reads out “There is an attached file.” However, the attached files are not always text information such as text data. The content is not read out because the files could be programs. It is desirable to add the function to stop reading in the middle of the mail, or skip reading in case there are too many mail, or the mail is too long. Or make it installable to set up when the received mail exceeds a appointed number. In this case, it is also desirable to make the computer read out the mail which was taken in by the e-mail fetching part 25 but not read out as saved mail, and make have it able to delete the next time the computer is turned on.

On the other hand, if there was no e-mail in the mail server 1 of the provider, there's no exchange with the mail server 1. Therefore, if the transmitting/receiving of data was not put into practice, the fixed sentences such as, “There's no mail, but maybe next time” and “There's no mail, but don't be sad. I'll be here”, are voice compounded and converted to voice signals when sent to voice compounding process part 28, sent to the speaker SP, and make the voice come out from the speaker when sent to voice output control part 29.

At this time, if the speaker SP of the stuffed animal 10 is installed inside the stuffed animal 10, the user feels as if the stuffed animal is the one who notifies whether there is any received mail and reads out the content of the mail

(3): An explanation of the process of the e-mail fetching/reading apparatus based on a flowchart

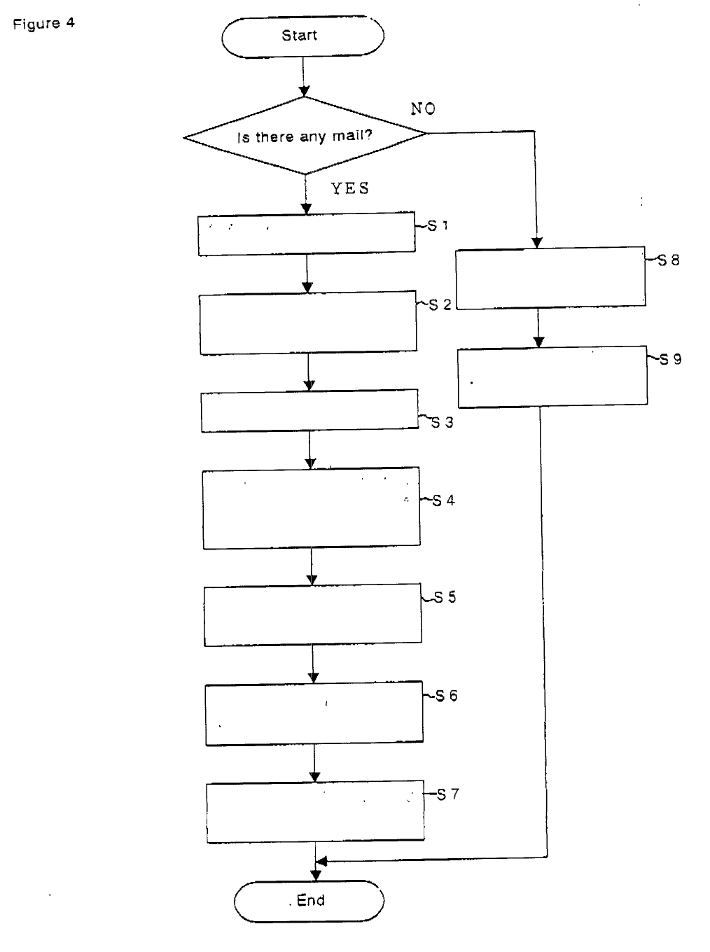

FIG. 4 is the flowchart of the process of the e-mail fetching/reading apparatus. The following is the explanation of said process of the e-mail fetching/reading apparatus based on a flowchart. S1-S7 shows each of the process step.

E-mail fetching part 25 acquires e-mail from the mail server 1 of the provider (S1), mailer information analyzing part 26 analyzes the information in the header section (mailer information) (S2). Then sentence editing part 27 receives the result data and which inserts said appointed information in the mailer information into the appointed place in the appointed sentence and edits (S3).

Then, based on the edited sentences, first, extract the number of the received mail, the number of the senders, send to voice compounding process part 28, voice compound and convert to voice signals (S4). Next, send the information of the header section to voice compounding process part 28, voice compound and convert to voice signals (S5). Then, extract the content in the body, send to voice compounding process part 28, voice compound and convert to voice signals (S6). After that, based on said voice signals, the voice output control part 29 sends the voice signal to the speaker SP and have the voice come out from the speaker SP (S7). Therefore, the stuffed animal 10 reads the mail out.

On the other hand, when there is no mail to the mail server 1 of the provider, the fixed sentences are sent to voice compounding process part 28 and voice compounded and converted to voice signals (S8). Then voice output control part 29 sends the voice signals to the speaker SP, and make the voice come out from the speaker and tell that there was no mail.

(4): An explanation of the process of the mailer information analyzing part

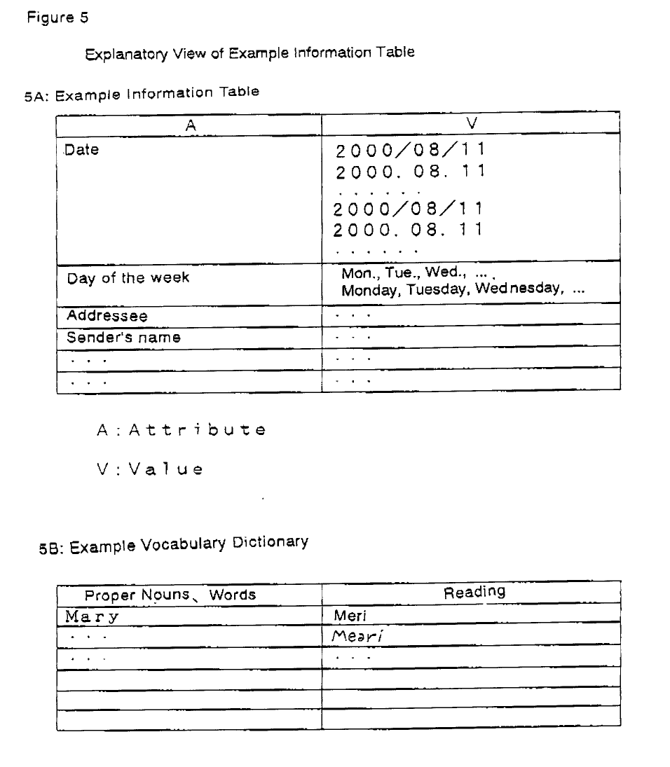

FIG. 5 is the explanatory view of the tables. FIG. 5A is the example of the information table. The detailed explanation of the process of mailer analyzing part is done referring to this view.

E-mail consists of the header and the body. The body is the content of the e-mail, which is the body of the information you want to tell, therefore, if it is voice compounded and make an output, it is possible to make an output understandable by human. Whereas, the header is a part to write perfunctory items of the mail and the writer writes in free format. Consequently, the mailer information of the header section is normally not written in unified format. The format of the header is written in a free style, and different in format depending on the provider,

By the way, the header has date of the transmission, day of the week, addressee (includes name, nickname, mail address, company name, organization name, position), sender (includes same information as the addressee) written in a free style. For example, if the date is 2000/08/11, it could be written as “2000/08/11” and “2000.08.11” If the day of the week is Monday, it could also be written as “Monday” and “Mon.”

There is no unified format for the mailer information of the header and it is written in a format a sender wishes (the format is different depending on the mailer of the mail soft). Therefore, the mailer information of the header section becomes a voice not understandable when voice compounded. There, it is necessary to analyze the content of the mailer information of the header section and uniform into words in a data form already appointed.

This way, mailer information analyzing part 26 analyzes the mailer information written in the header section of the e-mail. This analysis is practiced by using the information table shown in FIG. 5A for example. Aforesaid information table consists of A (attribute) and V (value) as items and the information of A and V are housed in each table.

According to this table, if V=either “2000/08/11” or “2000.08.11”, it is recognizable that A=date. If V=Monday, Tuesday, Wednesday, . . . , Mon., Tue., Wed., . . . , it is recognizable that A=day of the week.

Likewise, create a table with information of A and V housed in the memory part 8 of PC 3 and utilize it in the analysis of the mailer information. In this analysis, reference to the information table analyzes said V, extracts A and append A.

Therefore, extract words which is appointed information in order from said mailer information. At each word, referring to the information table search for the V information (aforesaid word), demand A for that V when the search is done, and append A to said word. For example, there is “2000.08.11” in the mailer information. It searches for the applicable words from the V information table, if there are applicable words, it judges that words relate to “date” A. Append the letter “date” to said word “2000.08.11”, and recognizes as date is “2000.08.11.”

Moreover, if there is a letter “Mon.” in the mailer information, it searches for the applicable words from the V information table. If there are words applicable, those words are judged that words relate to “day of the week” A. Append the letter “day of the week” to said word “Mon.”, and recognizes as “day is Mon.”

In this case, to recognize “Mon.” as “Monday”, set up another information table with collection of words. It is capable of recognizing by referring to this table data.

By doing so, e-mail mailer information analyzing part analyzes the mailer information written in header section of the e-mail, converts to the words in appointed form, and rearranges words in appointed order.

(5): The process of the sentence editing part

Sentence editing part 27 inserts each word that mailer information analyzing part 26 analyzed and rearranged into the appointed place in the appointed fixed sentence and edits to make the sentence understandable by deleting words meaningless (ex. punctuation marks) when read.

For example, prepare a sentence “The mail \mathring{1} is the mail from \mathring{3} of \mathring{2} to \mathring{4}.” Insert appointed attribute words in \mathring{1}-\mathring{4} and deletes meaningless letters when read.

In this case, define \mathring{1} as “date”, \mathring{2} as “company's organization”, \mathring{3} as “sender's name”, \mathring{4} as “name of addressee”. By setting up the attributes and the order of the words to insert into \mathring{1}-\mathring{4} the editing of the mailer information can be done easily and automatically. Moreover, when the information table V does not include applicable words in the mailer information, have it insert a word “none”. This way, it can read out “Title is none” when the title in the mail is not written.

By structuring this way, if there are two mails in the user's mail server, it reads out “There are two mails.” If those two mails are from “Mr. Aoki” and “Mr. Tanaka”, it reads out “Mails are from Mr. Aoki and Mr. Tanaka.” If the title of the mail from Mr. Aoki is “Air plane ticket”, it reads out “This is the mail from Mr. Aoki.”, “The title is Air plane ticket.” and the content of the body “. . . the body of the mail . . . , ” When it finishes reading the mail from Mr. Aoki, it reads the mail from Mr. Tanaka the same way. And if there is an attached mail, it reads out “There is an attached file.”

Prepare variety of expressions necessary for the sentences to insert into said \mathring{1}-\mathring{4}. Save this in the editing program or hard disk apparatus and it will be easy to edit process.

(6): An explanation of the voice compounding process

FIG. 5 is the explanatory view of the tables. FIG. 5B shows the vocabulary dictionary. Voice compounding process part 28 voice compound processes the sentence edited by sentence editing part 27. This voice compound process is done by using the former voice compounding soft (program). However, there are times when the sentences are not read correctly when the terms including Chinese characters are inputted into former voice compounding soft. Accordingly, add a vocabulary dictionary as shown in FIG. 5B beforehand and operate a voice compound process by referring to the dictionary.

Said dictionary has proper nouns and other words which probably have problems reading and use what correspond to the reading. For example, a name “Mary” could be read “meri” or “meari” or “mari. So when the word “Mary” comes up, have it respond with one of the reading. If it is prepared with a vocabulary dictionary, it is capable of reading the e-mail correctly by referring to voice compound process.

(7): An explanation of the specific example of the stuffed animal

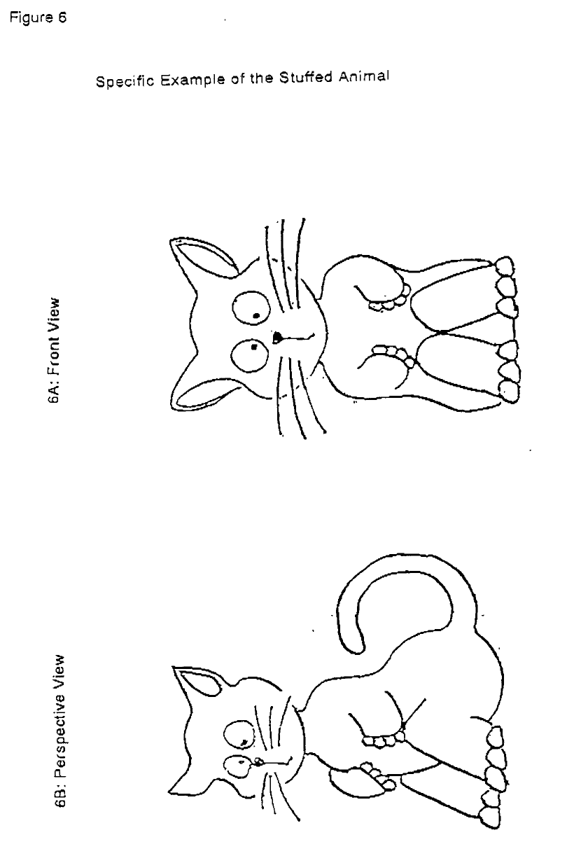

FIG. 6 is a specific example of the stuffed animal. FIG. 6A is the front view and FIG. 6B is the side view. Said stuffed animal 10 can be structured by any animal, for example, a cat, a mouse, or a dog. For example, it can be structured by a cat stuffed animal like shown in FIG. 6.

In this case, microphone MIC, speaker SP, switch SW are built-in inside the cat stuffed animal 10, and each is connected to appointed places inside the PC 3 electrically by lead line.

Moreover, it is possible to have the stuffed animal make specific movements. For example, if there was no e-mail in the mail server 1 and there was no transmitting/receiving done, e-mail fetching part 25 signals that does not have any data to receive. That signal makes the motor built-in the stuffed animal and not in the figures to shake its head right and left. At the same time the speaker SP makes an out put “There is no mail, but maybe next time”, the stuffed animal will shake its head left and right and make it feel stronger affinity towards the stuffed animal.

(8): An explanation of the program and the recording medium FIG. 7 is the specific apparatus example. E-mail Fetching/Reading Apparatus consists of PC 3 and stuffed animal 10. In this case, PC 3 is consisted of the body of the computer 31, display apparatus 4, input apparatus 5, RDD 34, and HDD 35. And the body of the computer 31 has CPU 41 (main control part 6), ROM 42 (non-volatile memory), RAM (memory with notes) 43, interface control part (I/F control part) 44, and communication control part 7 installed.

Said structure of apparatus, for example, have ROM 42 or disk (recording medium) of HDD 35 house a program to put e-mail fetching/reading process into practice (e-mail fetching/reading process program). Have CPU 41 put e-mail fetching/reading into practice. To house e-mail fetching/reading process program inside HDD 35, normally, install the program recorded on the recording medium such as CD-ROM.

However, this invention is not just limited to this example, and it is possible to house the program as the following in HDD 35, and have it put in practice with CPU 41,

\mathring{1}: Have RDD 34 read programs created by other apparatus and housed in removable disk and house the program into a disk of HDD35.

\mathring{2}: Have the communication control part 7 receive programs sent from other apparatus through the network. Received data is to be housed in HDD 35 disk.

§3: other explanations

(1): The stuffed animal 10 does not have to be limited to stuffed animals. I could be a mascot or a toy for example. Moreover, it could be plants, minerals, anything.

(2): In said example, the e-mail fetching/reading apparatus is consisted of PC 3 and stuffed animal 10. It is also possible to have PC 3 built in the stuffed animal 10. Moreover, the access to the provider could be done wireless with cell phone (internet access function).

There are following effects of the invention.

(a): According to the invention mentioned in claim 1, it makes automatic access to the mail server 1 through the network when the apparatus is started, check if there is any e-mail in the mail server 1, and tell the user by voice whether or not there is any mail. It is possible to check if there's any mail without operating the troublesome and burdensome computer.

(b): According to the invention mentioned in claim 2, it reads by voice the number of received messages in the mail server, appointed information such as the dates, sender's names or the titles included in the mailer information and/or the content of the e-mail mentioned as the body if there's received e-mail. By structuring this way, reading the content of the e-mail is possible without troublesome and burdensome operations of the PC.

(c): According to the invention as described in claim 3, the e-mail fetching part 25 makes access to the mail server automatically through the network, and acquires e-mail addressed to oneself. The mailer information analyzing part 26 extracts appointed information from the mailer information in the header section of the e-mail and converts the information to words in the data form determined in advance. The sentence editing part inserts said appointed information in the mailer information into the appointed place in the appointed sentence and edits. The voice compounding process part 28 compounds the content recorded as the mailer information and the body into a voice. And the electric sound converting means converts the voice signal to a voice and makes an output. By structuring this way, it is possible to check the necessary e-mail information by voice and get rid of troublesome and burdensome operations of the PC.

(d): According to the invention as described in claim 4, the mailer information analyzing part 26 practices the analysis referring to an already instituted information table about the mailer information such as the dates, sender's names, and title, demands an attribute in each word, attaches the attribute to the each word and converts into a word in the data form, and rearranges the words into a appointed order. By structuring this way, it is possible to extract necessary information such as date, sender's name, title, etc. in a specific form from the mailer information described in the header section.

(e): According to the invention as described in claim 5, the sentence editing part 27 inserts the words said mailer information analyzed and rearranged into the appointed place in the appointed sentence, deletes meaningless words when read by voice, and edits so that the sentence is easy to understand. By structuring this way, it is possible to convert into a sentence easy to understand when read out loud.

(f): According to the invention as described in claim 6, the voice compounding process part 28 refers the dictionary with proper nouns (person's names, place names) and other words which are likely to appear in e-mail and their pronunciations registered, and compounds into voice. By structuring this way, there is less misacquires reading and it can change to words easier to listen.

(g): According to the invention as described in claim 7, in the e-mail fetching/reading apparatus as defined in any of claims 3 to 6, at least the electric sound converting means (speaker SP) is put inside the stuffed animal 10. By structuring this way, it is possible to make it seem as it the stuffed animal 10 is the one who notifies whether there is any received mail and reads out the content of the mail.

(h): According to the invention as described in claim 8, the computer readable recording medium which has a program to notify whether there is any e-mail received at a mail server by making access to a mail server 1 automatically through the network. By structuring this way, checking e-mail is possible without troublesome and burdensome operations of the PC.

(i): According to the invention as described in claim 9, the computer is able to read what is recorded in the recording medium and put it into practice. It reads by voice the number of received messages in the mail server, appointed information such as the dates, sender's names or the titles included in the mailer information and/or the content of the e-mail. By structuring this way, reading the content of the e-mail is possible without troublesome and burdensome operations of the PC.

What is claimed is:

1. An e-mail fetching/reading apparatus structured to notify a user by voice whether there is any e-mail addressed to the user and received at a mail server by making access to the mail server automatically through a network.

2. An e-mail fetching/reading apparatus as defined in claim 1, characterized in that said apparatus reads by Voice the number of received messages addressed to the user in the mail server, appointed information such as the dates, sender's names or titles included in mailer information s and/or the content of the e-mail mentioned as the body.

3. An e-mail fetching/reading apparatus as defined in claim 2, characterized in that said apparatus includes, an e-mail fetching part which makes access to the mail server automatically through the network, acquires e-mail(s) addressed to the user,
a mailer information analyzing part which extracts appointed information from the mailer information in the header section of the acquired e-mail and converts the information to words in the data form determined in advance,
a sentence editing part which inserts said appointed information analyzed in the mailer information into appointed place(s) in the appointed sentence and edits,
a voice compounding process part which compounds the content recorded as the mailer information and the body into a voice signal,
an electric sound converting means which converts the voice signal to a voice and makes an output.

4. An e-mail fetching/reading apparatus as defined in claim 3, characterized in that the mailer information analyzing part practices an analysis with referring to a pre-instituted information table about the words such as the dates, sender's names and titles included in the mailer information, identifies an attribute for each word, attaches the attribute to the each word and converts into a word in the predetermined data form, and rearranges the words into an appointed order.

5. An e-mail fetching/reading apparatus as defined in claim 3, characterized in that the sentence editing part inserts the words, which are analyzed and rearranged by said mailer information analyzing part, into the appointed place in the appointed sentence, deletes meaningless words or characters when read by voice, and edits so that the sentence is easy to understand.

6. An e-mail fetching/reading apparatus as defined in claim 3, characterized in that said apparatus includes,
a dictionary with proper nouns and other words, which are likely to appear in the e-mail(s), and their pronunciations corresponding thereto, and,
the voice compounding process part has a function which refers this dictionary and compounds the voice signal.

7. An e-mail fetching/reading apparatus as defined in any of claims 3 to 6, characterized in that at least the electric sound converting means of the e-mail fetching/reading apparatus is put inside the stuffed animal.

8. A computer readable recording medium which has a program to notify a user by voice whether there is any e-mail addressed to the user and received at a mail server by making access to the mail server automatically through a network.

9. A computer readable recording medium as defined in claim 8, characterized in that the computer is functioned to read by voice the number of received messages addressed to the user in the mail server, appointed information such as the dates, sender's names, the title in the mailer information and/or the content of the e-mail mentioned as the body.
